(19) United States
(12) Patent Application Publication
(10) Pub. No.: US 2018/0082414 A1
(43) Pub. Date: Mar. 22, 2018

(54) Methods Circuits Assemblies Devices Systems Platforms and Functionally Associated Machine Executable Code for Computer Vision Assisted Construction Site Inspection

(71) Applicant: Astralink Ltd., Tel-Aviv (IL)

(72) Inventors: Ronen Rozenberg, Tel Aviv (IL); Matan Gidnian, Ra'anana (IL); Roiy Goldschmidt, Tel Aviv (IL)

(21) Appl. No.: 15/708,309

(22) Filed: Sep. 19, 2017

Related U.S. Application Data
(60) Provisional application No. 62/397,395, filed on Sep. 21, 2016.

(51) Int. Cl. G06T 7/00; G06T 7/73

(52) U.S. Cl. CPC G06T 7/001; G06K 9/00624; G06T 7/75

(57) ABSTRACT

Disclosed are methods, circuits, assemblies, devices, systems, platforms and functionally associated machine executable code for computer vision based inspection. A mobile device is used to acquire a digital representation of a real-world construction site scene. The acquired digital image is analyzed to recognize and extract potential features of construction related objects. Construction related objects are identified in the scene based on the extracted features. Objects within the digitized scene are compared to and aligned with objects within a corresponding 3D construction site model and the position and orientation from which the digital representation was acquired is found. Differences between parallel objects in the digitized scene and the 3D model are registered and indicated by augmenting visual representations of the differences on a digital display of the mobile device.

### RELATED APPLICATIONS

This application claims the priority of applicant's U.S. Provisional Patent Application No. 62/397,395, filed Sep. 21, 2016. The disclosure of the above mentioned 62/397,395, Provisional patent application, is hereby incorporated by reference in its entirety for all purposes.

### FIELD OF THE INVENTION

The present invention generally relates to the fields of digital inspection of construction, building and manufacturing and of object-model verification. More specifically, the present invention relates to methods, circuits, assemblies, devices, systems, platforms and functionally associated machine executable code for computer vision assisted construction site inspection and detail augmentation.

### BACKGROUND

Imaging and spatial data acquisition of different environments have been available for several years now as well as Computer Aided Design (CAD) models which are the digital representation of a physical object to be manufactured/built. In some industries, there is a need to verify that an object which have been manufactured/built is according to the CAD model that represents it. In particular, to assure the quality and usability is the same as intended while the object was planned.

Methods used today for object-model verification enable a one to one verification in which all of the relevant digital object parts are captured in the actual physical environment. Those methods for capturing physical spatial data and verification include the use of human inspection of captured images from cameras and depth sensors data (point cloud, mesh, etc.).

There remains a need, in the fields of digital inspection of construction, building and manufacturing and of object-model verification, for methods facilitating the understanding of the physical area, rather than aiming to build a better digital model representing the area scanned. Furthermore, if a physical environment is partially built and is not similar to the digital representing model, existing methods lack ability to assess differences between the two—for example, a wall which is being constructed does not look similar to its digital model until it is finished.

### SUMMARY OF THE INVENTION

The present invention includes methods, circuits, assemblies, devices and functionally associated computer executable code for computer vision assisted construction site inspection.

One or more sensors, including a camera, of a computerized device may be utilized to digitize a scene of a construction site within which a user of the device is present. Features and feature sets in the digitized scene may be extracted and compared to features within a set of 3-dimensional construction site models stored on a communicatively associated/networked database(s). Extracted features and/or construction associated objects derived therefrom, identified within one or more of the 3-dimensional construction site models may indicate the specific construction site within which the computerized device user is present, the location of the computerized device user within the site and the orientation of the computerized device at that location.

The expected view features and objects within the image frame of a camera of the computerized device at the specific site and the specific location and device orientation within it—based on the corresponding 3-dimensional construction site model—may be compared to extracted view features and/or derived objects from the actual digitized scene. Object differences between: (1) expected views, of one or more construction stage(s), depicted within the 3-dimensional construction site model of the specific site; and (2) view objects derived from features extracted from the actual digitized scene; may be characterized and augmented onto the image(s) acquired/being-acquired by the camera (i.e. the camera's field of view, viewable by the user) of the computerized device—such that, the camera's view of the scene and the augmented object differences, are collectively displayed to the user of the device.

Object differences and augmentations based thereof, in accordance with some embodiments, may include: adding objects, object parts and/or features missing from the actual digitized scene; marking/pointing/highlighting objects and/or features present at the actual digitized scene but missing from the respective 3-dimensional site model; and/or marking/pointing/highlighting differences in the size, shape, position and/or orientation of objects identified as similar in both, the actual digitized scene and the respective 3-dimensional site model.

According to some embodiments, there may be provided a computer vision based inspection system comprising: (a) a Scene Digitizer; (b) a Vector Model Processor; (c) a Self-Localization Unit; (d) a Scene Inspector unit; (e) a Scene Inspection Result Logger; (f) an Error Indicator Unit (e.g. AR rendering); and/or (g) a Construction Completion Engine.

A scene digitizer, in accordance with some embodiments, may include: a camera, a 3D camera, one or more additional sensors (e.g. accelerometer, magnetometer, gyroscope); a Feature Detector; and/or a Feature Extractor. The scene digitizer, optionally and/or partially implemented on/as-part-of a mobile computerized device or appliance, may utilize one or more of the cameras and/or sensors to acquire a current digital representation/image of a real-world construction site scene as viewed from the specific position and at the specific angle of view, in which the scene digitizer is oriented. The feature detector may analyze the acquired digital image to recognize potential features (e.g. construction related features which are part of a construction object—for example, 4 corners of a window) within it. The extractor may extract from the image dimension and orientation related parameters associated with the detected features.

A vector model processor, in accordance with some embodiments, may include a visual object generator, for identifying objects in the digitized scene based on the detected and extracted features, wherein identifying objects may include referencing a database of construction object examples and/or construction site 3-dimensional models and objects thereof. Identified objects may include: currently visible objects, extrapolated objects and predictive objects. The identified objects may be used as: a reference for self-localization of the scene digitizer at a specific construction site, at a specific building stage, location and/or orientation within the construction site; and/or for construction inspection reference.

A self-localization unit, in accordance with some embodiments, may determine what the scene digitizer's camera(s) is looking at within the reference frame of the vector. The self-localization unit may compare the objects identified within the digitized scene and their orientation to one or more 3-dimensional construction site models stored on a communicatively associated/networked database(s).

The 3-dimensional models may include construction site feature and object parameters of various construction sites and of various construction stages thereof. The comparison of the scene features/objects to the models may be utilized for self-localization of the scene digitizer (e.g. mobile computerized device) and its user, at a specific site, at a specific location within the site, at a specific stage (e.g. construction stage—current, prior, or upcoming) of the works performed/to-be-performed at the site and/or at a specific orientation and thus viewing angle position—based on similar features, objects and/or scene characteristics identified in both and matched.

A scene inspector unit, in accordance with some embodiments, may compare expected view objects, from the 3-dimensional model of a matching site, with objects of the digitized scene. The scene inspector unit may compare the objects identified within the digitized scene and their dimensional and structural characteristics to those in a matching view (same position and angle) in a matching 3-dimensional construction site model stored on a communicatively associated/networked database(s). The comparison of the scene objects to the objects in the matching model may be utilized for registering differences and deltas between parallel objects in the two, indicative of non-complete, erroneously completed and/or prior to schedule complete objects.

A scene inspection result logger, in accordance with some embodiments, may record the registered differences and deltas between parallel objects, within the scene objects and the objects in the matching model, to a communicatively associated/networked database(s). The results of the comparison may be used as a reference for augmentation and presentation of the object differences and deltas to system users.

An error indicator unit (e.g. an augmented reality rendering unit), in accordance with some embodiments, optionally and/or partially implemented on/as-part-of a mobile computerized device, may indicate detected errors/differences between parallel objects and/or object sets, found within both the scene objects and the objects in the matching model.

Object differences/errors/deltas may optionally be presented as a real-time visual overlay on the scene being displayed to the system user, optionally over the display of the mobile computerized device. Indicated object differences/errors/deltas may include, visually marking: objects or object-features missing from the actual digitized scene; objects or object-features present at the actual digitized scene but missing from the respective 3-dimensional site model; differences in the size, shape, position and/or orientation of objects or object-features identified as similar in both the scene and the model, for example in non-complete objects/features; objects or object-features associated with later or alternative construction stages/plans.

A construction completion engine, in accordance with some embodiments, may predict and indicate/present/augment fully built, or later building stage built, view(s) of scene objects based on the existing partially-built ones. Having previously identified the construction stage, specific textural features of partially-built objects (e.g. before pouring concrete, iron bars should appear on the wall/floor to be casted) and properties of the objects from the respective 3-dimensional model of the building (e.g. the wall object is expected to be flat and not curved) the completed look of the object in a later or completed stage may be deducted. Properties of neighboring objects may also be analyzed to learn about the object of interest or the building stage.

Once the objects are identified (e.g. a semi built wall is identified as a wall), their size and properties may be predicted. The fully built, or later building stage built, view(s) of scene objects may be based on fitting between the partially captured object in the digital image captured and a plane. The size and borders of the plane may be set from the captured image and the curvature of the plain (i.e. like a two-dimensional manifold) may be derived from the 3-dimensional model.

According to some embodiments, multiple scene images which are the result of a digitized walk through the scene of a construction site may be recorded for future/deeper inspection. Multiple recorded image sets from the same site, may for example be utilized for identifying and pointing out differences not only between a viewed scene of a site and a corresponding model, but also between multiple views of the same site. For example, multiple ‘digitized walk’ views, each including multiple scenes of the same site, at different stages of construction—may be used to estimate the pace at which the works at the site are being performed and to identify holdbacks and bottlenecks in the work process.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings:

FIG. 1A is a block diagram showing the main components and component relationships of a first exemplary system for computer vision assisted construction site inspection, in accordance with some embodiments;

FIG. 1B is a flowchart showing the main process steps executed by an exemplary system for computer vision assisted construction site inspection, in accordance with some embodiments;

FIG. 2 is a block diagram showing the main components and component relationships of a second exemplary system for computer vision assisted construction site inspection, in accordance with some embodiments;

FIG. 3A is a block diagram of an exemplary scene digitizer, in accordance with some embodiments;

FIG. 3B is a flowchart showing the steps executed as part of an exemplary process for digitizing a scene, in accordance with some embodiments;

FIG. 4A is a block diagram of an exemplary vector model processor, in accordance with some embodiments;

FIG. 4B is a flowchart showing the steps executed as part of an exemplary process for generating a vector model and utilizing it for defining and identifying detected and extracted features, in accordance with some embodiments;

FIG. 5A is a block diagram of an exemplary self-localization unit, in accordance with some embodiments;

FIG. 5B is a flowchart showing the steps executed as part of an exemplary process for the positioning of a scene digitizer and its user within a site, in accordance with some embodiments;

FIG. 6A is a block diagram of an exemplary scene inspector unit and an exemplary scene inspection result logger, in accordance with some embodiments;

FIG. 6B is a flowchart showing the steps executed as part of an exemplary process for comparing expected view features, from a 3-dimensional model of a matching site, with features of a digitized scene and for logging registered differences, in accordance with some embodiments;

FIG. 7A is a block diagram of an exemplary error indicator unit, in accordance with some embodiments;

FIG. 7B is a flowchart showing the steps executed as part of an exemplary process for indicating detected errors/differences between parallel features/objects and/or feature/object sets of a construction site, in accordance with some embodiments;

FIG. 8A is a block diagram of an exemplary construction completion engine, in accordance with some embodiments;

FIG. 8B is a flowchart showing the steps executed as part of an exemplary process for construction completion, in accordance with some embodiments;

FIG. 9 is a 3D model snapshot of an exemplary construction scene view including a window object and features thereof, in accordance with some embodiments;

FIG. 10 is an image of an exemplary partially built wall, acquired at a construction site, in accordance with some embodiments;

FIGS. 11A-11B are images of an exemplary wall opening error, detected in an image acquired at a construction site, in accordance with some embodiments, wherein the wall image is shown prior to (11A) and following to (11B) the rendering of a graphical augmentation of the wall opening;

FIGS. 12A-12B are images of an exemplary door opening error, detected in an image acquired at a construction site, in accordance with some embodiments, wherein the wall image is shown prior to (12A) and following to (12B) the rendering of a graphical augmentation of the door opening;

FIGS. 13A-13B are an exemplary digital image of a specific scene of a construction site (13A) and an exemplary 3D model snapshot corresponding to the digital image of the specific scene (13B), in accordance with some embodiments;

FIGS. 14A-14B are an exemplary digital image of a specific scene of a construction site (14A) and an exemplary 3D model snapshot corresponding to the digital image of the specific scene (14B), wherein compatible points for alignment, in accordance with some embodiments, are augmented onto both the image and the snapshot;

FIG. 15A is a flow-diagram of an exemplary system for computer vision assisted construction site inspection, utilized for construction model based indication and visualization of: differences, errors, irregularities and/or following construction stages, in accordance with some embodiments;

FIG. 15B is a diagram showing an exemplary user and mobile-device interaction, in accordance with some embodiments of the present invention, wherein the user is requested to point and touch the screen of the multi-touch mobile display at his relevant location; and

FIG. 15C is a diagram showing an exemplary mobile-device usage scheme, in accordance with some embodiments of the present invention, wherein the user points the mobile device towards a construction site scene.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Unless specifically stated otherwise, as apparent from the following discussions, it is appreciated that throughout the specification discussions utilizing terms such as “processing”, “computing”, “calculating”, “determining”, or the like, may refer to the action and/or processes of a computer, computing system, computerized mobile device, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In addition, throughout the specification discussions utilizing terms such as “storing”, “hosting”, “caching”, “saving”, or the like, may refer to the action and/or processes of ‘writing’ and ‘keeping’ digital information on a computer or computing system, or similar electronic computing device, and may be interchangeably used. The term “plurality” may be used throughout the specification to describe two or more components, devices, elements, parameters and the like.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device, for example a computerized device running a web-browser.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and an optical disk. Some demonstrative examples of optical disks include compact disk-read only memory (CD-ROM), compact disk-read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution. The memory elements may, for example, at least partially include memory/registration elements on the user device itself.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments, or vice versa.

Throughout the specification, the term ‘3D-Model’, and/or any other more or less specific terms such as: ‘3 dimensional model’, ‘3-dimensional model’ ‘model’, ‘construction model’, ‘construction plans’, ‘2D blueprints/views’ or the like, is not to limit the scope of the associated teachings or features, all of which may apply to any form of digital construction or production plans known today, or to devised in the future, such as, but not limited to—Computer Aided Design (CAD) models which are the digital representation of a physical object to be manufactured/built.

The following descriptions are generally directed and exemplified in the context of computer vision assisted construction site inspection. This is not limit, however, the teachings of the present invention to the field of building and/or construction. Various production, assembly, manufacturing and/or fabrication processes and systems, to name a few, may implement and benefit from the teachings herein.

The present invention includes methods, circuits, assemblies, devices and functionally associated computer executable code for computer vision assisted construction site inspection.

One or more sensors, including a camera, of a computerized device may be utilized to digitize a scene of a construction site within which a user of the device is present. Digitized scene data and/or features and feature sets in the digitized scene may be extracted, communicated to a system server and compared to features within a set of 3-dimensional construction site models stored on database(s) communicatively associated/networked with the system server. Extracted features and/or construction associated objects derived therefrom, identified within one or more of the 3-dimensional construction site models may indicate the specific construction site within which the computerized device user is present, the location of the computerized device user within the site and the orientation of the computerized device at that location.

The expected view features and objects within the image frame of a camera of the computerized device at the specific site and the specific location and device orientation within it—based on the corresponding 3-dimensional construction site model—may be compared to extracted view features and/or derived objects from the actual digitized scene. Object differences between: (1) expected views, of one or more construction stage(s), depicted within the 3-dimensional construction site model of the specific site; and (2) view objects derived from features extracted from the actual digitized scene; may be characterized and augmented onto the image(s) acquired/being-acquired by the camera (i.e. the camera's field of view, viewable by the user) of the computerized device—such that, the camera's view of the scene and the augmented object differences, are collectively displayed to the user of the device.

Object differences and augmentations based thereof, in accordance with some embodiments, may include: adding objects, object parts and/or features missing from the actual digitized scene; marking/pointing/highlighting objects and/or features present at the actual digitized scene but missing from the respective 3-dimensional site model; and/or marking/pointing/highlighting differences in the size, shape, position and/or orientation of objects identified as similar in both, the actual digitized scene and the respective 3-dimensional site model.

According to some embodiments, there may be provided a computer vision based inspection system comprising: (a) a Scene Digitizer; (b) a Vector Model Processor; (c) a Self-Localization Unit; (d) a Scene Inspector unit; (e) a Scene Inspection Result Logger; (f) an Error Indicator Unit (e.g. AR rendering); and/or (g) a Construction Completion Engine.

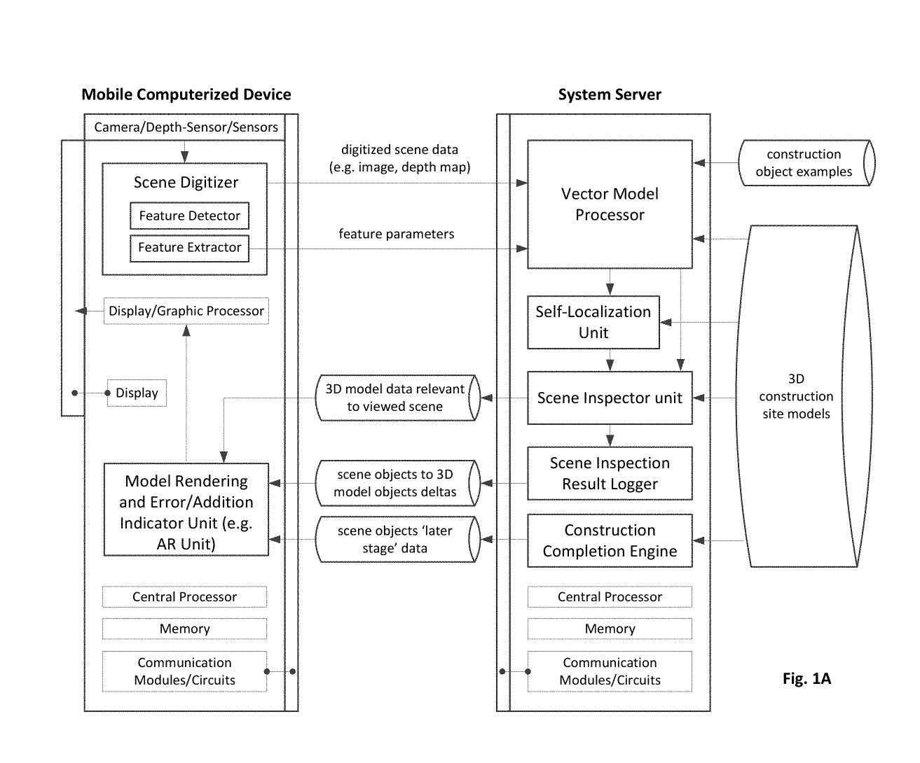

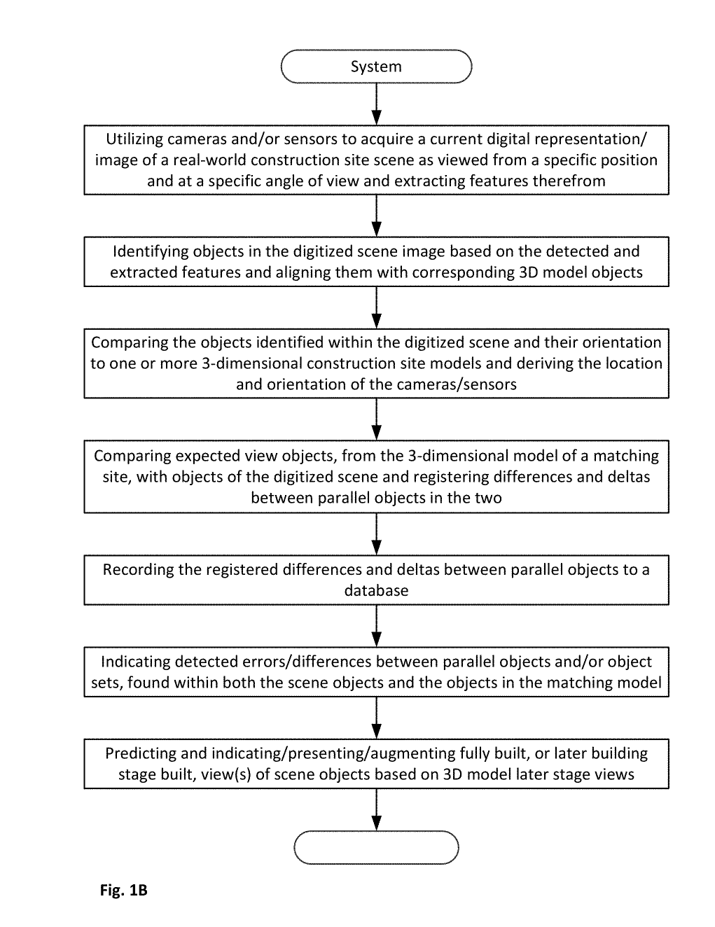

In FIG. 1A there is shown a block diagram of the main components and component relationships of a first exemplary embodiment of a system for computer vision assisted construction site inspection, in accordance with some embodiments.

In the figure there are shown a Mobile Computerized Device and a System Server. The mobile device includes a Scene Digitizer for receiving output signals from: a camera, a depth sensor and/or additional sensors, connected to the mobile device or integrated thereto and viewing/sensing a scene of a construction site. Electric sensor signals may optionally be digitized by the Scene Digitizer. Shown feature detector and feature extractor, of the Scene Digitizer, may respectfully, identify and extract the characteristics of, features within the provided sensor outputs (e.g. camera image, depth map), for example, by utilizing edge and point detection and/or background removal techniques.

Digitized scene data (e.g. camera image, depth map) and the extracted feature characteristics (e.g. features' shape, dimensions, orientation) are relayed to the Vector Model Processor of the System Server. The Vector Model Processor may identify extracted features based objects and structures within the digitized scene, by referencing databases storing records of construction object examples and 3D construction site models. The relevant construction site model, in accordance with some embodiments, may be preselected by the user of the mobile device and likewise relayed to the server.

The shown Self-Localization Unit, based on the objects and structures identified in the scene and the referencing of the relevant model within the 3D construction site models database, aligns the acquired scene image/representation with a matching view of the relevant 3D model (e.g. all/most objects in scene are aligned with their corresponding model objects). The position, orientation and viewing/sensing angle of the mobile device within the construction site is thus triangulated and found.

The shown Scene Inspector/Inspection Unit shown, based on the localization data relayed to it, the referencing of the 3D construction site models database and the digitized scene image/representation, compares the actual scene view at the site to a corresponding view (i.e. from same position, orientation and view angle) within the relevant 3D model. Differences between the two are identified and measured and relayed to the Scene Inspection Result Logger for storage in the shown—scene objects to 3D model objects deltas database.

The Construction Completion Engine shown, retrieves from the 3D construction site models database, later construction stage data relevant to the objects within the viewed scene of the relevant construction site model. Later construction stage data is stored in the shown—scene objects ‘later stage’ data database.

On the mobile device, the shown Model Rendering and Error/Addition Indicator Unit (e.g. AR Unit)—by referencing: the scene objects to 3D model objects deltas database, the scene objects ‘later stage’ data database and/or the shown 3D model data relevant to viewed scene—renders visual presentation instructions for the augmentation of differences/deltas between the 3D model and the actual viewed/sensed construction site scene. Augmentation data of differences/deltas, or later construction stages differences/deltas, is relayed to the display/graphic processor of the mobile device and presented on the screen of the mobile device to the user as an overlay on: the 3D model view, the actual view being acquired by the camera of the mobile device and/or a combination of both.

In FIG. 1B there is shown a flowchart of the main process steps executed by an exemplary system for computer vision assisted construction site inspection, in accordance with some embodiments.

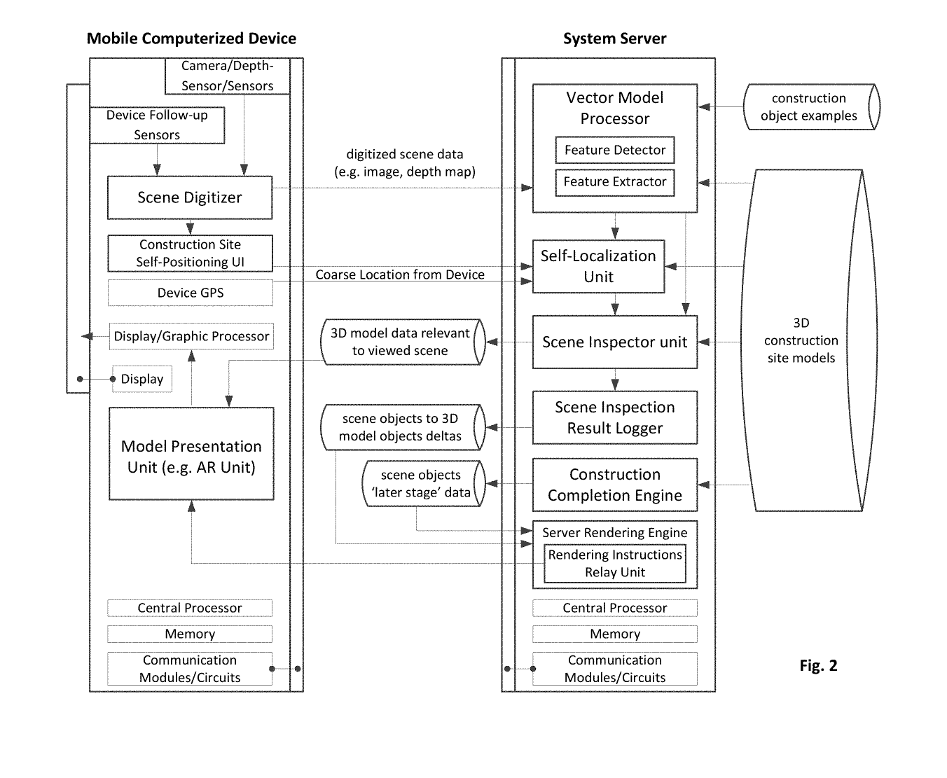

In FIG. 2 there is shown a block diagram of the main components and component relationships of a second exemplary embodiment of a system for computer vision assisted construction site inspection, in accordance with some embodiments.

In the exemplary embodiment depicted in the figure, there are shown, further to the components of FIG. 1A, a construction site self-positioning user interface (UI) and a GPS unit of the mobile device. The UI may allow for the user to provide his location within a given construction site by positioning himself over a 2D blueprint(s) of the construction site, retrieved by the system server from the 3D construction site models database and relayed to the mobile device. The user selection may, for example, be obtained through a screen touch of the user at the relevant position on the blueprint presented on a touchscreen display of the device and/or by his pointing of a cursor to the relevant position on the blueprint. User selected and/or mobile device GPS based positioning data may then be relayed to the Self-Localization Unit of the system server for allowing for, or assisting with, the positioning of the user and thus the mobile device, within the actual construction site.

The system server in the shown embodiment further includes a Server Rendering Engine for generating visual presentation rendering instructions for the augmentation of differences/deltas between the 3D model and the actual viewed/sensed construction site scene. The shown Rendering Instructions Relay Unit communicates the already generated rendering instructions to a Model Presentation Unit of the mobile device.

The shown mobile device further includes Device Follow-up Sensors, for example, in the form of an inertial measurement unit (IMU) that electronically measures and reports the mobile devices' specific force, angular rate and/or magnetic field surroundings, using a combination of accelerometers and gyroscopes and/or magnetometers. Device Follow-up Sensors are utilized to follow the movement of the mobile space, deducting its ever changing position, orientation and/or viewing angle, as the user moves through the construction site—which is also referred to herein as the user's ‘tour’ or ‘virtual tour’.

A scene digitizer, in accordance with some embodiments, may include: a camera, a 3D camera, one or more additional sensors (e.g. accelerometer, magnetometer, gyroscope); a Feature Detector; and/or a Feature Extractor. The scene digitizer, optionally and/or partially implemented on/as-part-of a mobile computerized device, may utilize one or more of the cameras and/or sensors to acquire a current digital representation/image of a real-world construction site scene as viewed from the specific position and at the specific angle of view, in which the scene digitizer is oriented. The feature detector may analyze the acquired digital image to recognize potential features (e.g. construction related features which are part of a construction object—for example, 4 corners of a window) within it. The extractor may extract from the image dimension and orientation related parameters associated with the detected features.

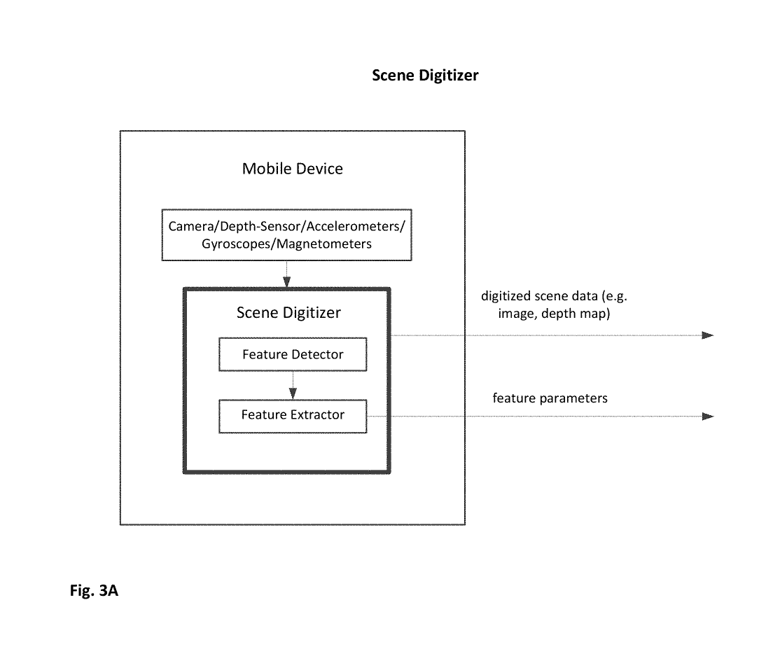

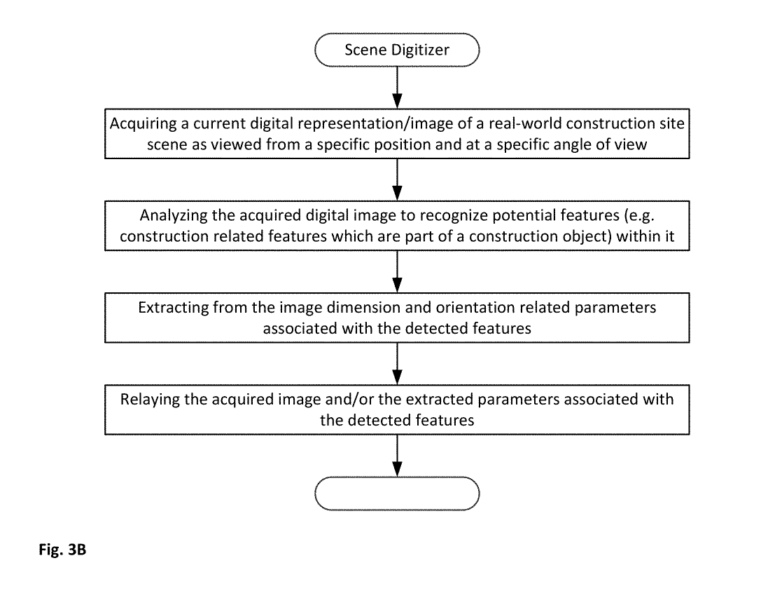

In FIG. 3A there is shown a block diagram of an exemplary embodiment of a scene digitizer, in accordance with some embodiments. In the figure, there is shown a scene digitizer installed onto or integrated into a mobile computerized device. The scene digitizer receives the output signals from a selection of shown mobile device sensors, including: a camera, a depth sensor, accelerometers, gyroscopes and/or magnetometers. Digitized scene data, for example in the form of a digital image and a depth map, of the viewed scene, is generated by the scene digitizer. Generated data is relayed to the system server and to the shown feature detector for search of potential construction objects related features. Potential features and their position within the digitized scene are relayed to the shown feature extractor for extraction of properties such as their: dimension, orientation, texture, color and/or the like. Extracted feature data is then relayed to the system server.

In FIG. 3B there is shown a flowchart showing the main steps executed as part of an exemplary process for digitizing a scene, in accordance with some embodiments.

A vector model processor, in accordance with some embodiments, may include a visual object generator, for identifying objects in the digitized scene based on the detected and extracted features, wherein identifying objects may include referencing a database of construction object examples and/or construction site 3-dimensional models and objects thereof. Identified objects may include: currently visible objects, extrapolated objects and predictive objects. The identified objects may be used as: a reference for self-localization of the scene digitizer at a specific construction site, at a specific building stage, location and/or orientation within the construction site; and/or for construction inspection reference.

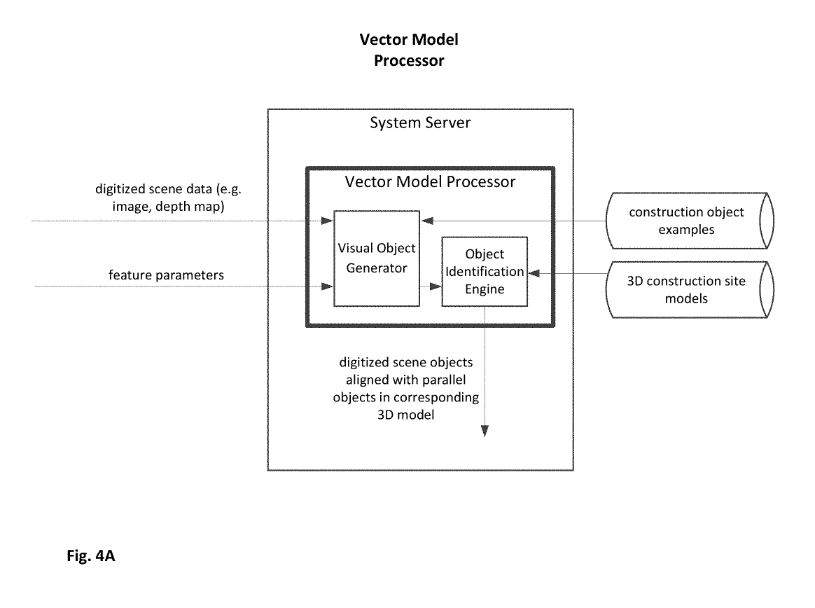

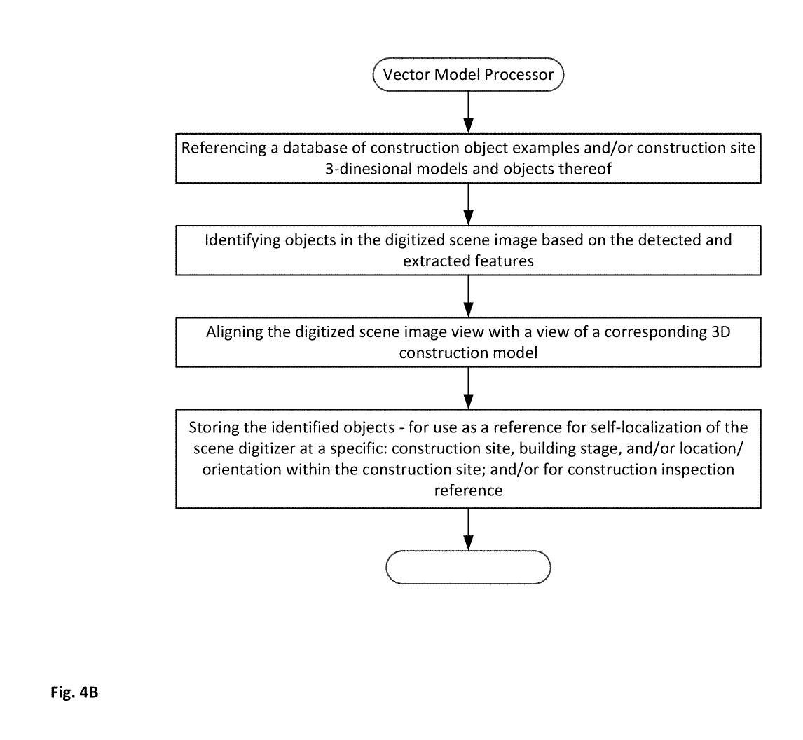

In FIG. 4A there is shown a block diagram of an exemplary embodiment of a vector model processor, in accordance with some embodiments. In the figure, there is shown a vector model processor installed onto or integrated into a system server. The vector model processor receives digitized scene data and scene features' parameters. By referencing a construction object examples database the shown visual object generator estimates which construction related objects, which are-based-on/include the features, or a subset of the features, for which parameters were received—are present in the digitized scene. The shown object identification engine uses the estimated scene present object data to try and identify similar matching objects within a 3D construction site model corresponding to the viewed scene and to utilize the similar identified objects for aligning the digitized scene image with a matching 3D model snapshot. The object identification engine then relays parameters/data related to the digitized scene objects aligned with parallel objects in the corresponding 3D model.

In FIG. 4B there is shown a flowchart showing the main steps executed as part of an exemplary process for vector modeling a digitized scene, in accordance with some embodiments.

A self-localization unit, in accordance with some embodiments, may determine what the scene digitizer's camera(s) is looking at within the reference frame of the vector. The self-localization unit may compare the objects identified within the digitized scene and their orientation to one or more 3-dimensional construction site models stored on a communicatively associated/networked database(s).

The 3-dimensional models may include construction site feature and object parameters of various construction sites and of various construction stages thereof. The comparison of the scene features/objects to the models may be utilized for self-localization of the scene digitizer (e.g. mobile computerized device) and its user, at a specific site, at a specific location within the site, at a specific stage (e.g. construction stage—current, prior, or upcoming) of the works performed/to-be-performed at the site and/or at a specific orientation and thus viewing angle position—based on similar features, objects and/or scene characteristics identified in both and matched.

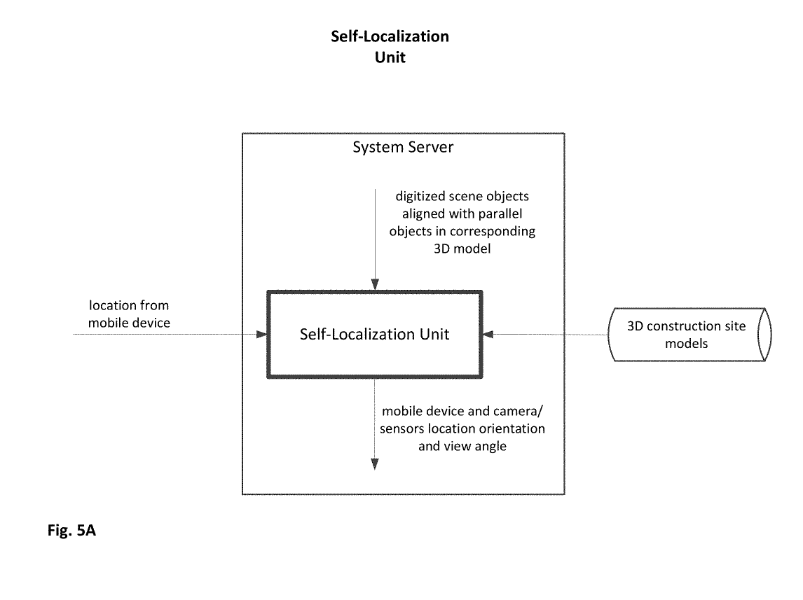

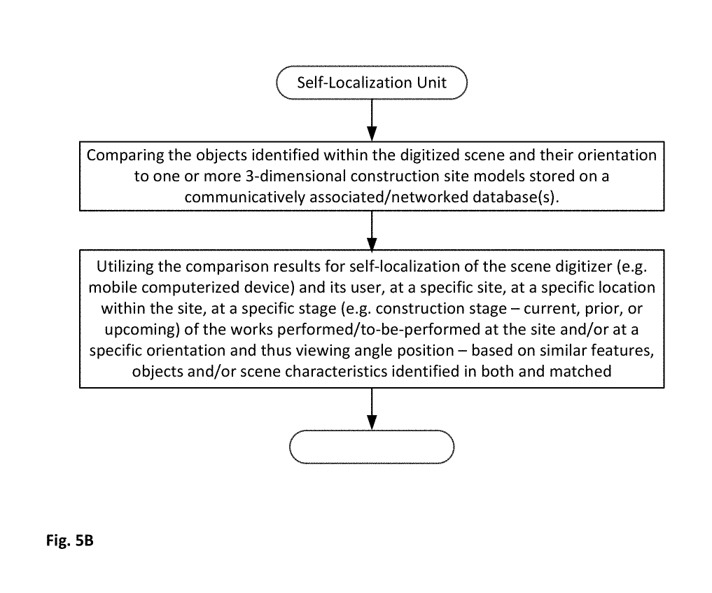

In FIG. 5A there is shown a block diagram of an exemplary embodiment of a self-localization unit, in accordance with some embodiments. In the figure, there is shown a self-localization unit installed onto or integrated into a system server. The self-localization unit receives parameters/data related to the digitized scene objects aligned with parallel objects in the corresponding 3D model and optionally, the coarse location of the mobile device (e.g. user entered, GPS based). Based on aligned scene objects and by referencing the 3D construction site models database, the self-localization unit utilizes triangulation techniques to find the location, orientation and view angle of the mobile device and/or camera/sensors thereof within the actual construction site. Location/Positioning data is then relayed.

In FIG. 5B there is shown a flowchart showing the main steps executed as part of an exemplary process for self-localization, in accordance with some embodiments.

A scene inspector unit, in accordance with some embodiments, may compare expected view objects, from the 3-dimensional model of a matching site, with objects of the digitized scene. The scene inspector unit may compare the objects identified within the digitized scene and their dimensional and structural characteristics to those in a matching view (same position and angle) in a matching 3-dimensional construction site model stored on a communicatively associated/networked database(s). The comparison of the scene objects to the objects in the matching model may be utilized for registering differences and deltas between parallel objects in the two, indicative of non-complete, erroneously completed and/or prior to schedule complete objects.

A scene inspection result logger, in accordance with some embodiments, may record the registered differences and deltas between parallel objects, within the scene objects and the objects in the matching model, to a communicatively associated/networked database(s). The results of the comparison may be used as a reference for augmentation and presentation of the object differences and deltas to system users.

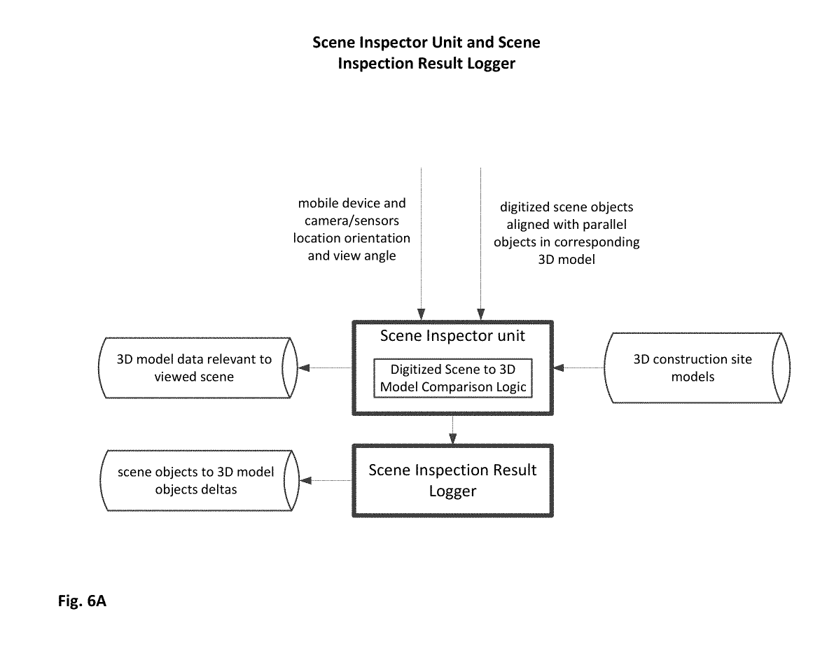

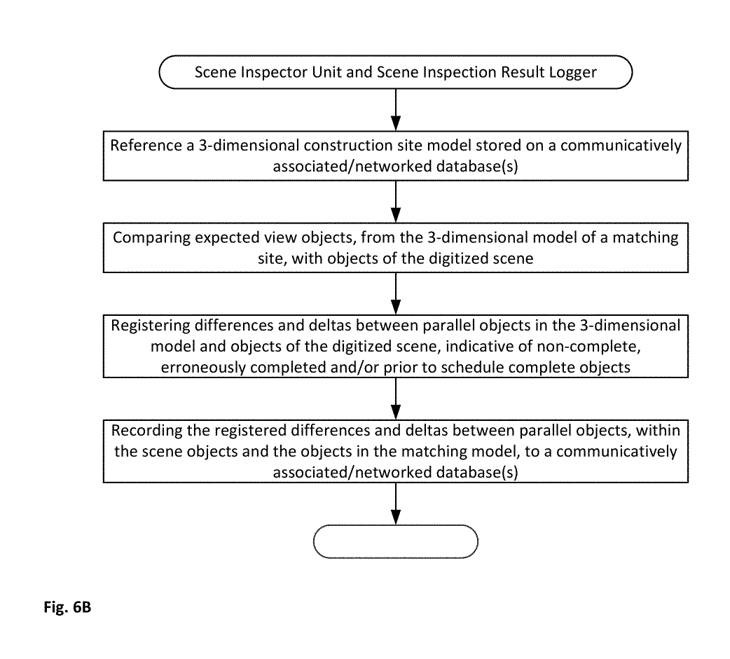

In FIG. 6A there is shown a block diagram of an exemplary embodiment of a scene inspector unit and a scene inspection result logger, in accordance with some embodiments. In the figure, there are shown a scene inspector unit and a scene inspection result logger installed onto or integrated into a system server. The scene inspector unit receives mobile device and camera/sensors location, orientation and view angle parameters/data; and digitized scene objects aligned with parallel objects in a corresponding 3D model. Based on the received data and by referencing the 3D construction site models database, the shown digitized scene to 3D model comparison logic identifies differences between corresponding objects in the digitized scene and the 3D model and relays them to the scene inspection result logger for storage in the shown scene objects to 3D model objects deltas database.

In FIG. 6B there is shown a flowchart showing the main steps executed as part of an exemplary process for scene inspection and scene inspection result logging, in accordance with some embodiments.

An error indicator unit (e.g. an augmented reality rendering unit), in accordance with some embodiments, optionally and/or partially implemented on/as-part-of a mobile computerized device, may indicate detected errors/differences between parallel objects and/or object sets, found within both the scene objects and the objects in the matching model.

Object differences/errors/deltas may optionally be presented as a real-time visual overlay on the scene being displayed to the system user, optionally over the display of the mobile computerized device. Indicated object differences/errors/deltas may include, visually marking: objects or object-features missing from the actual digitized scene; objects or object-features present at the actual digitized scene but missing from the respective 3-dimensional site model; differences in the size, shape, position and/or orientation of objects or object-features identified as similar in both the scene and the model, for example in non-complete objects/features; objects or object-features associated with later or alternative construction stages/plans.

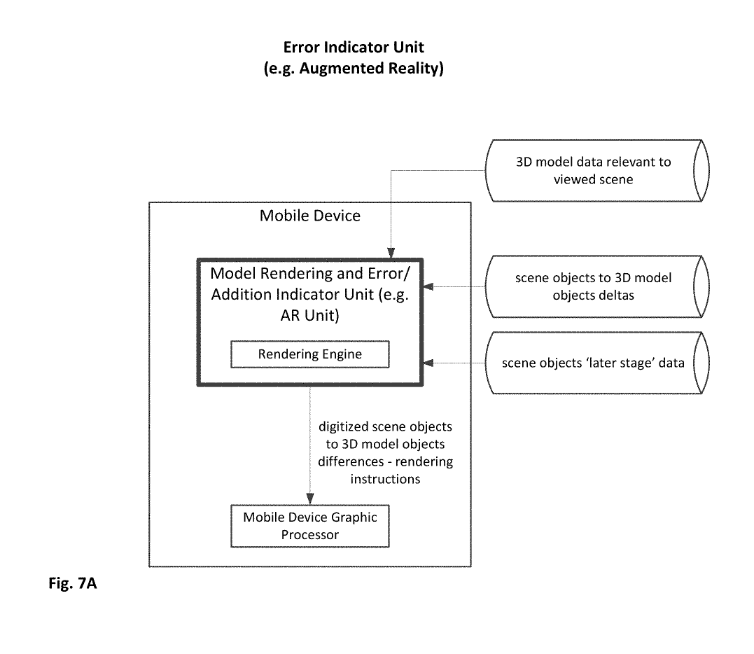

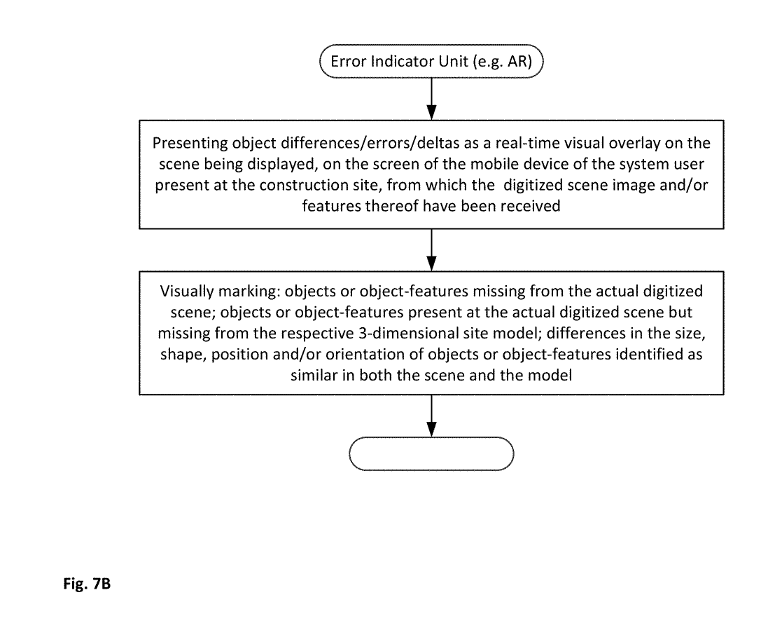

In FIG. 7A there is shown a block diagram of an exemplary embodiment of an error indicator unit, in accordance with some embodiments. In the figure, there is shown an error indicator unit installed onto or integrated into a mobile device. The error indicator unit references the scene objects to 3D model objects deltas database and based on data records thereof, utilizes its shown rendering engine to generate rendering instructions for the visual augmentation of the differences between the digitized scene objects and the 3D model objects. Similarly, the scene objects ‘later stage’ data database is referenced in order to generate rendering instructions for the visual augmentation of later construction stage object details. Generated rendering instructions are relayed to the mobile device graphic/display processor for presentation on the screen of the mobile device.

In FIG. 7B there is shown a flowchart showing the steps executed as part of an exemplary process for site scene error/difference indication, in accordance with some embodiments.

A construction completion engine, in accordance with some embodiments, may predict and indicate/present/augment fully built, or later building stage built, view(s) of scene objects based on the existing partially-built ones. Having previously identified the construction stage, specific textural features of partially-built objects (e.g. before pouring concrete, iron bars should appear on the wall/floor to be casted) and properties of the objects from the respective 3-dimensional model of the building (e.g. the wall object is expected to be flat and not curved) the completed look of the object in a later or completed stage may be deducted. Properties of neighboring objects may also be analyzed to learn about the object of interest or the building stage.

Once the objects are identified (e.g. a semi built wall is identified as a wall), their size and properties may be predicted. The fully built, or later building stage built, view(s) of scene objects may be based on fitting between the partially captured object in the digital image captured and a plane. The size and borders of the plane may be set from the captured image and the curvature of the plain (i.e. like a two-dimensional manifold) may be derived from the 3-dimensional model.

In FIG. 8A there is shown a block diagram of an exemplary embodiment of a construction completion engine, in accordance with some embodiments. In the figure, there is shown a construction completion engine installed onto or integrated into a system server. The construction completion engine receives digitized scene to 3D model comparison results from the scene inspector unit. The shown current construction site stage identifier uses the comparison results to determine the construction stage at which the actual site or scene are at and relays the determined stage data to the later construction site stage data retriever. The later construction site stage data retriever also receives an indication of the later construction stage selected for viewing by the system user. Knowing both the current and the selected ‘later’ construction stage, the later construction site stage data retriever references the 3D construction site models database and retrieves data indicative of the construction deltas between the current and selected stages, which construction deltas indicative data is stored to the shown scene objects ‘later stage’ data database, for referencing by the error indicator unit.

In FIG. 8B there is shown a flowchart showing the steps executed as part of an exemplary process for construction completion, in accordance with some embodiments.

According to some embodiments, multiple scene images which are the result of a digitized walk through the scene of a construction site may be recorded for future/deeper inspection. Multiple recorded image sets from the same site, may for example be utilized for identifying and pointing out differences not only between a viewed scene of a site and a corresponding model, but also between multiple views of the same site. For example, multiple ‘digitized walk’ views, each including multiple scenes of the same site, at different stages of construction—may be used to estimate the pace at which the works at the site are being performed and to identify holdbacks and bottlenecks in the work process.

According to some embodiments, an exemplary system, for computer vision assisted construction site inspection and for measuring predicted construction errors from a real-world construction scene, may comprise: (1) A real-world camera and/or a depth sensor for imaging the real-world construction scene from a real-world angle of view to acquire a current digital image of the real-world construction scene from the real-world angle of view; (2) A computer memory or database for storing a 3D model of a building to be built, the 3D model comprising a plurality of virtual objects; (3) An object identification engine for identifying partially-completed construction objects from one or more of the digital images of the real-world construction scene, wherein the identification is performed on two levels/stages: (a) Identifying the current construction stage—from one or several images of the real-world construction site, the current construction stage is derived, as each construction stage has unique features that differentiate it from other construction stages, the engine identifies the unique features; construction stage associated features may, for example, be derived by a proprietary, or a third party (e.g. TensorFlow), machine learning engine, wherein the engine is at least partially trained with feature labeled/designated images/representations of construction sites at specific known/designated stages of construction; (b) Once the construction stage is determined by the engine, the partially built objects in the scene (construction site) are identified, for example, a partially built wall is identified as a wall and the openings, in the identified wall, are identified as windows and doors respectfully.

According to some embodiments, the object identification engine may be at least partially based on deep learning schemes/models, tailored to facilitate construction scene object identification, wherein the learning, or training, of the model may include undergoing supervised “training” on multiple construction sites' images/digital-representations within which construction associated objects are already identified.

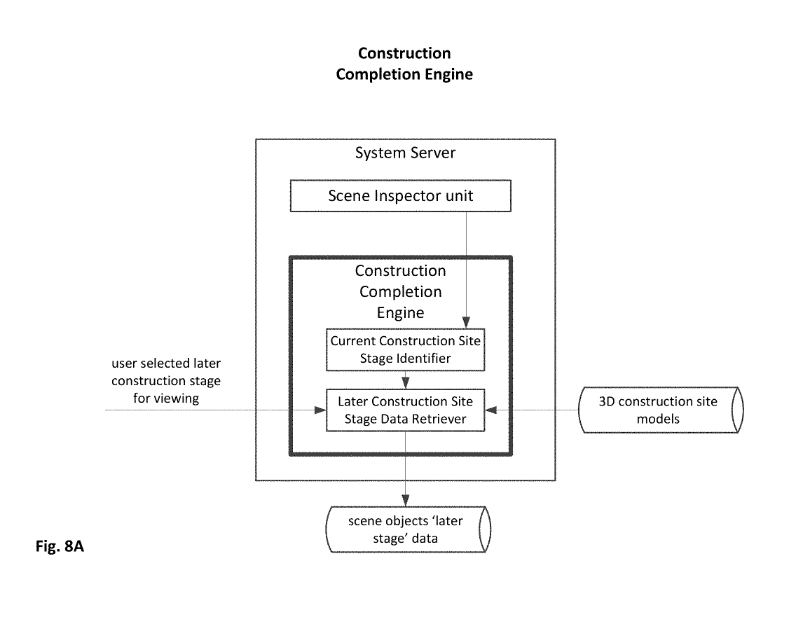

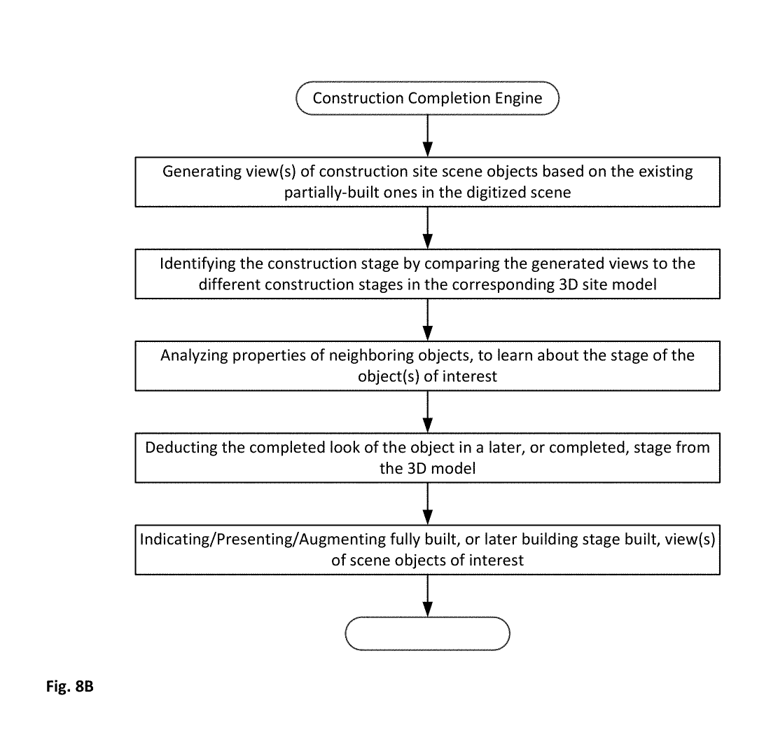

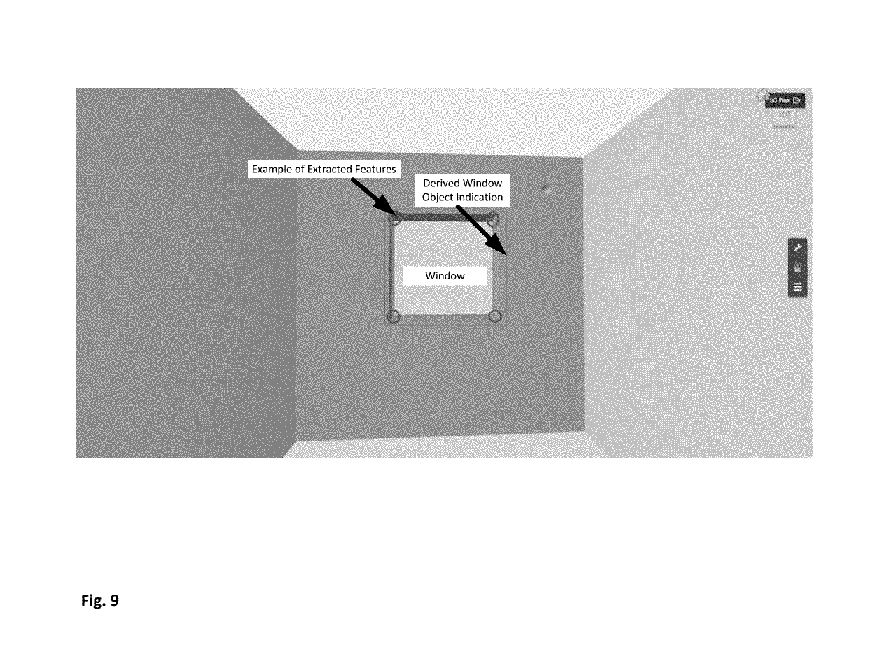

In FIG. 9 there is shown a 3D model snapshot of an exemplary construction scene view including a window object and features thereof, in accordance with some embodiments. In the figure, there are shown examples of features—four right angled corners collectively forming a square shape—identified within a digital image/representation of the construction scene and augmented (circled in red) onto the 3D model snapshot presented to the user. The object identification engine may conclude that the four right angled corners collectively represent a window object, based on their arrangement forming a square shape and/or based on other object rules or constrains, for example: the identification of the square's position substantially at the center of a vertical wall and not at the bottom of the wall (as the position a door would be at); and/or identification of the square shape, rather than a rectangular shape (as the shape of a door would be). Once identified, the object borders are augmented (lined in blue) onto the 3D model snapshot presented to the user. The user may than interface and select the identified and augmented object for further manipulation, for example, viewing augmentations of its later building stages.

According to some embodiments, the exemplary system, may further comprise: (4) A construction completion engine for predicting fully built objects from partially built ones (e.g. the fully built wall from a partially built wall). As the construction stage has been previously identified, specific textural features (e.g. before pouring concrete iron bars should show) of the partially built object and properties of the object from the 3D model of the building (e.g. the wall object is expected to be flat and not curved) are collectively utilized to complete the partially built object (e.g. generate data for presentation of the completed wall); properties of neighboring objects may also be examined and knowledge in regard to the object of interest, derived therefrom. Once the objects are identified (e.g. half build wall is identified as a wall), their size and properties are estimated/predicted.

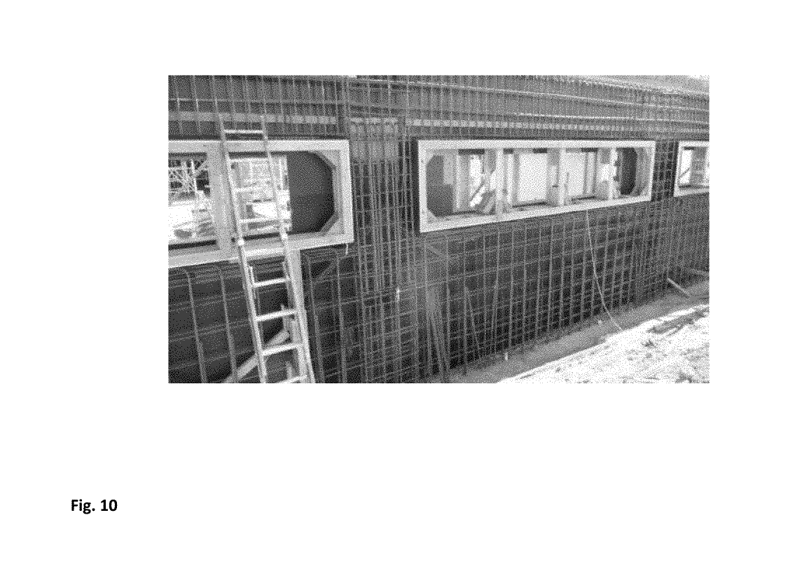

In FIG. 10 there is shown an image of an exemplary partially built wall, acquired at a construction site, in accordance with some embodiments.

According to some embodiments, predicting fully built objects from partially built ones may be at least partially based on plane fitting between the partially captured object in the digital image and a plane. The plane size and borders are set from the captured image and the curvature of the plane (e.g. as a two-dimensional manifold) is derived from the model.

According to some embodiments, the exemplary system, may further comprise: (5) An error detection engine for quantifying deviations between the completely-built (if the scene is not fully-built, the above presented prediction may be used) construction object and the construction object as represented within the 3D model of the building to be built. Exemplary detected errors in a construction site, may include, but are not limited to: (a) Wall openings—size of the openings (like windows and doors) on the walls and their relative location; (b) Wall angles and location; (c) Building systems and infrastructures—structure, size and location of air conditioning components, sprinklers, power sockets, piping and wiring layouts.

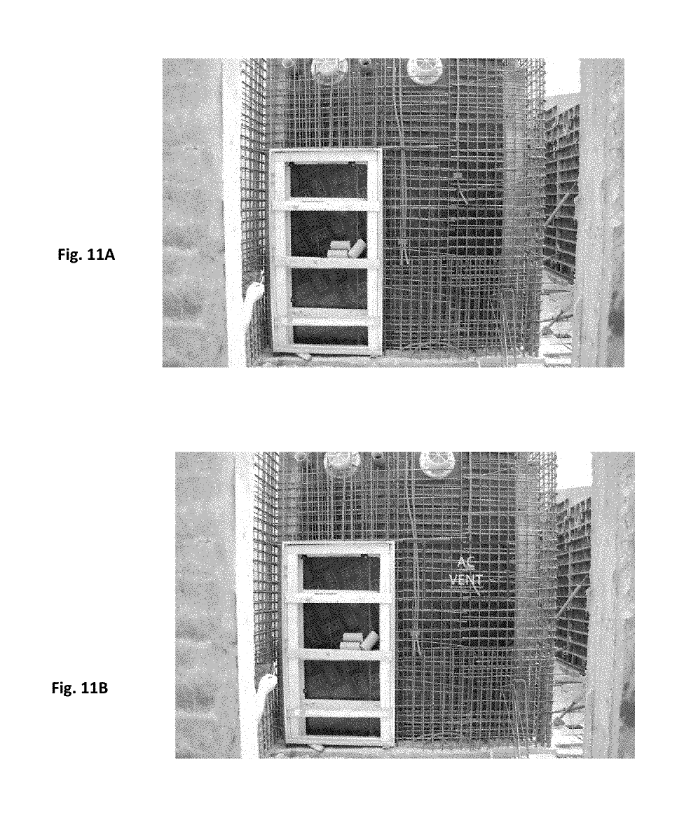

In FIGS. 11A-11B there are shown images of an exemplary wall opening error, detected in an image acquired at a construction site, in accordance with some embodiments, wherein the wall image is shown prior to (11A) and following to (11B) the rendering of a graphical augmentation of the wall opening which was erroneously not performed at the site. The positioning and dimensions of the required wall opening, as well as the intended purpose of the opening—an AC Vent, are derived by the error detection engine at least partially based on a respective 3D model of the construction site.

In FIGS. 12A-12B there are shown images of an exemplary door opening error, detected in an image acquired at a construction site, in accordance with some embodiments, wherein the wall image is shown prior to (12A) and following to (12B) the rendering of a graphical augmentation of the door opening which was erroneously not performed at the site. The positioning and dimensions of the required door opening, as well the intended look of the door to be positioned within it, are derived by the error detection engine at least partially based on a respective 3D model of the construction site.

According to some embodiments, the exemplary system, may further comprise: (6) A location-tracking engine for computing, by comparing content of the 3D model and the acquired current digital image, a current real-world location of the real-world camera and a current real-world view angle of the real-world camera; and/or optionally based on camera calibration data, wherein an initial camera-to-model calibration is utilized to extract a starting point (i.e. first user/user-device location/orientation) and the extracted starting point is then utilized as a reference point for a following user/user-device tracking—as the user moves-within/tours-through the construction site or parts thereof.

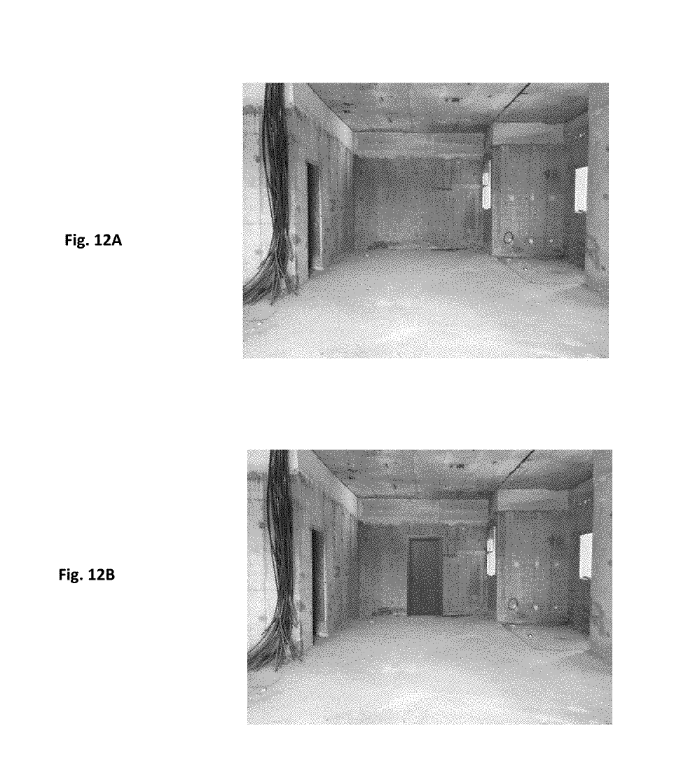

In FIGS. 13A-13B there are shown: a digital image of a specific scene of a construction site (13A) and a 3D model snapshot corresponding to the digital image of the specific scene (13B), in accordance with some embodiments.

Computing a current real-world location of the real-world camera and a current real-world view angle of the real-world camera may be based on finding features in the digital image and aligning them to features in the respective 3D model. Edge lines and points in the digital image are extracted and the corresponding points on the 3D model are found. Once the compatible points in the image and the model are matched, the location, positioning and orientation of the user/user-device/camera/depth-sensor/other-sensors may be calculated.

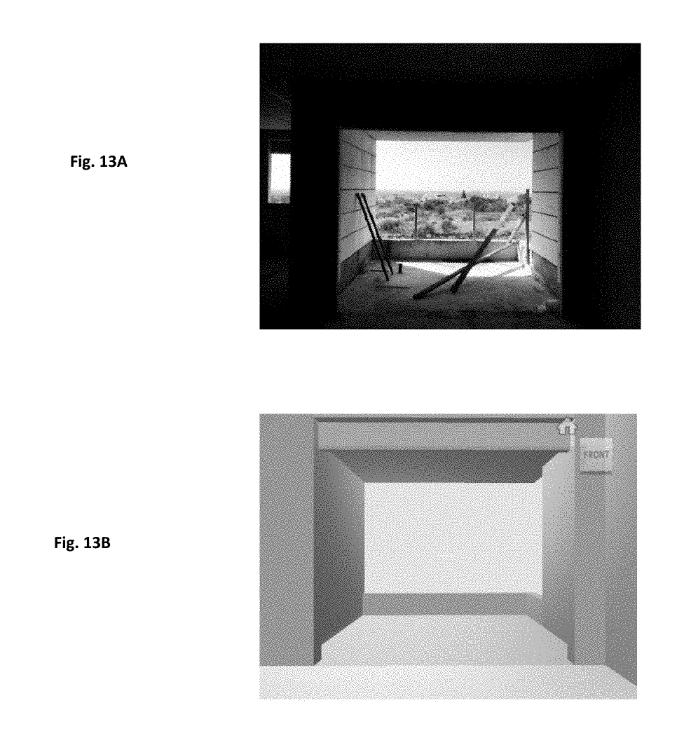

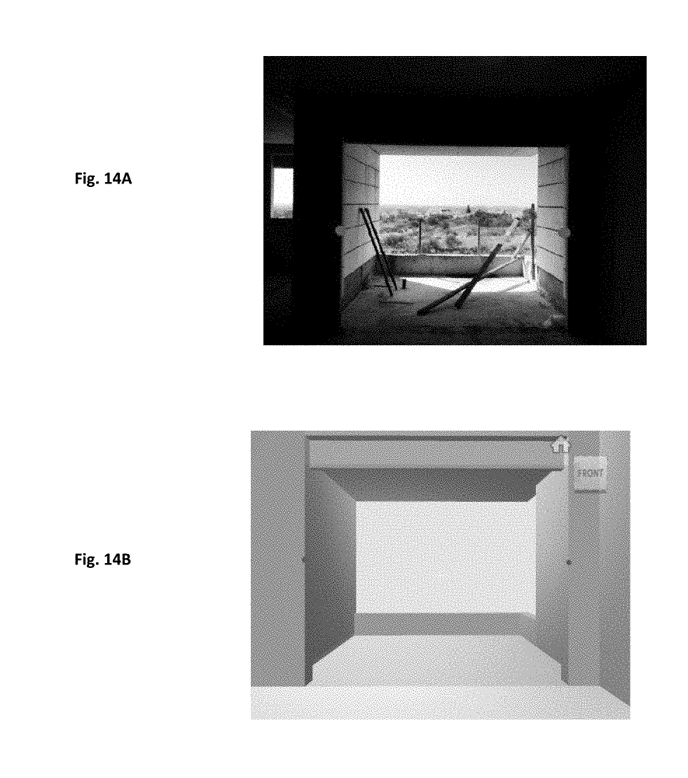

In FIGS. 14A-14B there are shown: a digital image of a specific scene of a construction site (14A) and a 3D model snapshot corresponding to the digital image of the specific scene (14B), in accordance with some embodiments, wherein exemplary compatible points for alignment are augmented onto both the image view (14A) and the corresponding 3D model snapshot view (14B).

According to some embodiments, knowing the “real” construction site scene object sizes—from the 3D model of the building (scene objects sizes/dimensions from the 3D model are compatible with the real-world construction site), may allow for triangulating and calculating the location/position of the user/user-device/camera/depth-sensor/other-sensors. The deviation of one or more center object(s) from the center of the image may allow for calculating the real-world viewpoint angle of the user/user-device/camera/depth-sensor/other-sensors.

Used image features may be based on “texturally rich” areas in the image, such as, but not limited to the detection of edge lines and edge points. The ‘strongest’, or most relevant/informative/accurate features—and/or the features' or feature-points' relative positioning—may be assessed based on the 3D model; and may thus allow for the selection of a set of the best feature points, from within the feature points identified in the image. For example, upon identification of a rectangular shape within the image/representation of a construction site, rectangle-corners (rectangle vertices) related features may be the ones extracted, rather than rectangle-sides related features which are considered inferior. Rectangle-sides related features may, for example, be considered inferior due to the fact that features of two opposite corners/vertexes define the entire rectangle, whereas features of all four sides of the rectangle will be needed to do the same.

According to some embodiments of the present invention, there may be provided an exemplary system and method for interactive visualization of construction site plans (e.g. 3D models) and for simultaneously calculating and visualizing inconsistencies between the plans of the viewed scene and the actual viewed construction status.

The exemplary system, in accordance with some embodiments, may comprise: (1) A mobile device with a substantially large screen (e.g. a tablet) comprising a multi-touch display (2) A functionally connected, or integrated, depth sensor; (3) An RGB camera; (4) An inertial measurement unit (IMU); and (5) A processor and a memory for storing instructions executable by the processor for displaying virtual objects.

According to some embodiments, the system may augment representations of between construction plans and an actual viewed/sensed given construction status, on the display/screen of the mobile device. The representations of inconsistencies may be augmented over the scene being captured by the camera and being presented (e.g. in real-time) on the display/screen of the mobile device.

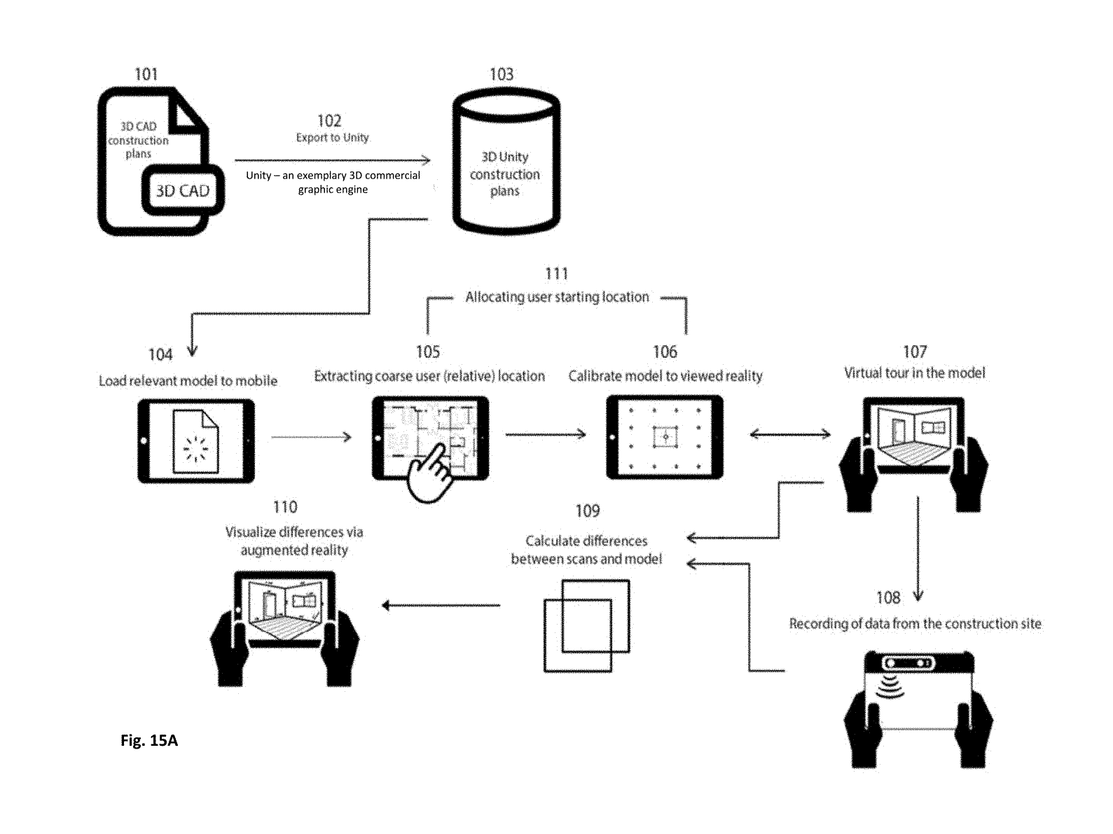

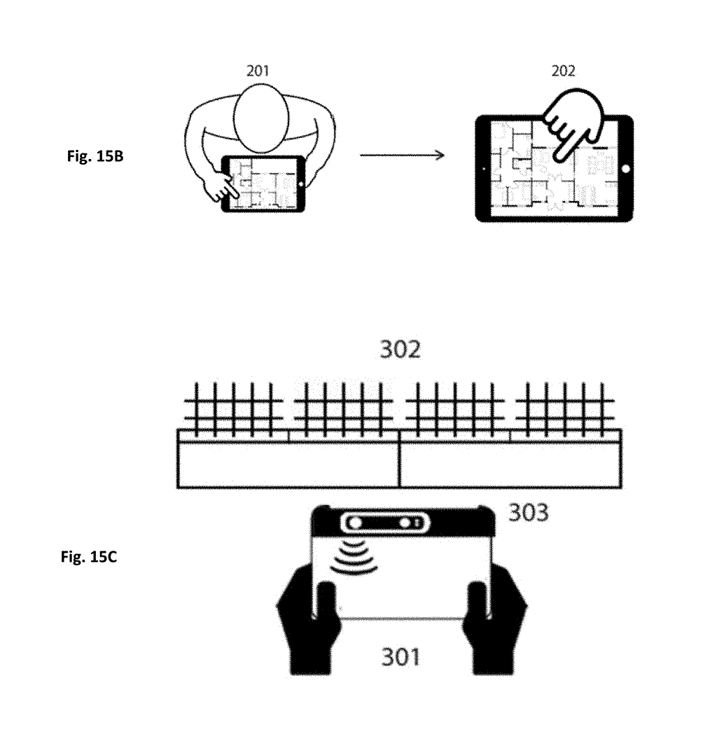

In FIG. 15A there is shown a flow-diagram of an exemplary system for visualization of a construction model and for the visual indication of differences and/or irregularities between the construction model and the status of an actual real construction site scene, in accordance with one embodiment of the present invention.

The presented exemplary flow, initiates with a data source (101), including 3D computer-aided design (CAD) construction plans and/or 2D blueprints. The data source (101) plans/models are the basis for digitized versions or models of the expected, current or future, constructed structure, in one or more real life construction sites.

Once the data source is provided, the different models are stored and organized (102) in a database (103). The database may optionally include 3D models stored in, or along with, a graphic engine (e.g. ‘Unity’—a cross-platform game/graphic engine used to develop video games and simulations for computers, consoles and mobile devices).

Each model may represent a specific construction project. According to one embodiments, the data source, for example the CAD(s), may be exported to a graphic engine (102), optionally, along with its relevant indicators and the reflective 2D blueprints. The indicators may include, for example, a construction project name and address. Furthermore it may include “object properties” inside the model, such as a window with its color and size along with other elements and/or objects. The indicators may be extracted from the data source (101) and stored in the database (103) alongside the relevant models. According to some embodiments, one or more additional indicators may be extracted and stored, such as the floor number, which represents the floor number of a specific model with respect to the overall construction structure.

According to some embodiments, the system may comprise a mobile device/unit, controlled by the user. The user can reference/load the chosen model and indicators (104) from the database via the mobile device. As described above, the mobile device may comprise of a tablet/portable/mobile device with multi-touch display, internet connection, processor, memory, RGB camera and a mounted depth sensor. The referencing/loading of the relevant data (104) by the user may be done over a network connection by which the portable device is connected to a system server communicatively associated with the database. The portable device comprises memory to facilitate the storage and later referencing of the data.

According to some embodiments, the system may derive the location of the user (111) relevant to the chosen, or automatically identified, model data. The user location deriviation may comprise a coarse user location understanding (105) and a fine calibration method (106) which aligns the model data with the user's relevant location within the construction site and his, or his mobile device's, viewpoint and view angle. The extraction of the user coarse location (105) may be done, according to some embodiments, by displaying to the user, on the portable devices' screen, the relevant construction blueprints, which may depict the chosen 3D model, or sections thereof, in a 2D environment/view. According to some embodiments, the user may be requested to point with his fingertip on the screen, his assumed location within the relevant construction site and/or its model. It should be appreciated, however, that this user input may not be required, or may be only partially utilized, in all embodiments of the present invention, as the coarse user location can be derived from the portable devices' GPS, based on cellular triangulation and/or in other ways. According to some embodiments, the location of the user may be at least partially derived based on the matching of—features and/or objects identified within the digital representation/image acquired by the mobile device at the actual construction site, to features and/or objects within stored 3D model(s) as described herein.

According to some embodiments, once the user allocation process (111) extracts the user's coarse location (105) with respect to the 2D blueprints, a more fine calculation of his viewpoint is calculated and the 3D model is aligned with reality viewed in the construction site (106). These calculations are consolidated by the calibration process (106) described in further detail herein. The calibration process (106) may be implemented, in order to align the virtual object with the reality captured with the mobile device. As described herein and illustrated in FIG. 15.

According to some embodiments, the calibration process is initiated once the relevant construction model planes (e.g. 3D model and 2D model) and indicators are provided (virtual objects) (104) along with the user coarse location in correspondence with the construction plan (105). The calibration process may make use of the provided virtual objects and the user known coarse location. Furthermore, according to some embodiments, it may use the images captured in real-time by the camera integrated in the mobile device and/or depth sensor, or other mobile device sensors. In other embodiments, the depth sensor connected to the mobile device may be used for calibration in combination with camera to obtain images in 2D and depth information in 3D of the observed construction site scene. The calibration adjusts the virtual object's size and orientation to fit with the viewed scene.

According to some embodiments, the calibration may, for example, be initiated every time a new virtual object is loaded and used and/or once the “virtual tour” in the virtual scene/object(s) (107) needs to recalibrate. According to some embodiments of the present invention, recalibration may be done, for example, when the user tracked viewpoint is lost and/or when the time from the last calibration breached a certain threshold.

According to some embodiments, once the virtual scene/object(s) were calibrated (106) to the user's viewpoint of the viewed scene, the virtual objects may be displayed on the screen of the mobile device and the user may be freed to “explore” around and inside the virtual objects within the construction site (107). For example, the user can observe the 3D model of the construction plans (107) while walking and pointing the mobile device at the real construction taking place. Post calibration user movements may be tracked and registered.

According to some embodiments, the tracking may be done by filtering the inertial measurement unit (IMU) signals. The IMU, incorporated into the mobile device, may consist of an accelerometer and a gyroscope that can be used for calculating relative change in viewpoint of the mobile device. Some embodiments may incorporate a simultaneous location and mapping (SLAM) algorithm—used to simultaneously localize (i.e. find the position/orientation of) some sensor with respect to its surroundings, while at the same time mapping the structure of that environment—in order to calculate relative viewpoint change.

According to some embodiments, in parallel to the “virtual tour” (107), the mobile device may record the camera images and the depth information (108). Those recordings can be, according to some embodiments, saved/stored. The various embodiments of saving the recorded data (108) may vary from saving records onto the mobile device to saving the records in a database communicatively associated with the system server. Different embodiments may vary in the extent of the recorded data (108), some embodiments may include all the data to be saved (on the mobile device or in the database) and some embodiments may include saving only the several last frames recorded. Other embodiments may include processing only the current frame captured without saving the recordings at all.

According to some embodiments, in addition to allowing the user to “tour” the virtual calibration objects in a simulated environment adjusted to the construction site (107), the system may calculate the differences between the planes and the current construction reality (109). The differences (109) reflect on the deviation of the actual construction from the designed plans and can indicate construction irregularities and errors. According to some embodiments, for example, the difference (109) may detect a current window construction in the wrong place and/or in the wrong size. Various differences/irregularities—varying from big and severe to small and minor—may be identified by the system of the invention, in accordance with some embodiments. According to some embodiments, the sensitivity of differences/irregularities identification may be tuned by the user, for example through a user interface of a computerized application running on the mobile device.

Once the differences between the virtual objects and the current construction reality are calculated (109), they may be visualized onto the screen of the mobile device, optionally in real-time (110). This visualization of the differences may be augmented on/over the project construction plans (110). According to some embodiments, the differences may be augmented on/over the current construction site (reality) (110), being captured by the mobile device camera in real-time and presented to the user on the screen of the mobile device (110). This may be done, for example, by use of a SLAM algorithm for building the current scene depth map, updating it and tracking it along the user movements.

According to some embodiments, an exemplary process flow of a system for visualization of a construction model and for the visual indication of differences/irregularities between the construction model and the status of an actual real construction site scene, may include: (1) receiving, at a system server, a user selection of a specific construction site from within a set of two or more different user-device-presented construction site choices; (2) displaying a visual representation of the selected construction site on the display of the user device; (3) receiving a user selection of a specific section (e.g. floor/level) of the displayed construction site; (4) receiving a user selection of a specific location (user location) within the selected section of the selected construction site; (5) displaying to the user of the device a 3D model view, corresponding to a real-life view made from the selected location within the selected section of the selected site; (6) receiving a user-selection of a specific object from the objects presented within the displayed 3D model view; (7) receiving a construction site image(s)/representation(s), made by the camera and/or other sensor(s) of the user device; (8) aligning the selected object, and thus the views, of the user-device acquired image/representation and the 3D model view; (9) using the aligned views as a starting position reference, as the user moves the device and directs it towards construction site objects of interest; (10) receiving a user selection of a specific object of interest towards which the device is directed; (11) displaying/indicating/augmenting over the display of the user device: (a) one or more differences between the selected object as imaged/represented in the site and as represented in the 3D model, (b) one or more differences between the selected object as imaged/represented in the site and as represented in following construction stage views (specific following stage may be selected by user) of the 3D model and/or (c) one or more sub-objects, or hidden (un-viewable/covert) sub-objects, of the selected object; and/or (12) optionally receiving a user selection of a displayed sub-object and repeating step 11 for the selected sub-object.

In FIG. 15B there is shown a user (201) and a mobile device (202). According to some embodiments of the present invention, also depicted in FIG. 15A block 105, the user is requested to point and touch the screen of the multi-touch mobile display at his relevant location on the 2D construction plan (blueprints) presented on the screen of the mobile device (202). This may provide the coarse user's relative location within/with-respect-to the current construction site.

In FIG. 15C there is shown a user pointing a mobile device (301) towards a construction site (302). According to some embodiments of the present invention, also depicted in FIG. 15B, the mobile device includes a camera and is mounted with a depth sensor (303). Examples of suitable depth sensor may include, but are not limited to: Occipitals' 3D sensor, Google 3D sensor (Tango) and Apple 3D sensor. Furthermore, the depth sensor mechanisms may capture depth at a sufficient frequency or frame rate to detect and optionally follow motions of the user and his held mobile device.

According to some embodiments of the present invention, a Computer Vision Based Inspection System may comprise: a Scene Digitizer for acquiring a current digital representation of a real-world construction site scene as viewed from a specific position and at a specific angle of view; a Feature Detector/Extractor for analyzing the acquired digital representation to recognize potential features of construction related objects within it and for extracting parameters associated with features' dimensions or orientation within the scene; a Vector Model Processor for identifying construction related objects or structures based on the detected and extracted features, wherein identifying objects or structures at least partially includes referencing a database of construction sites' 3-dimensional models including objects or structures thereof; and/or a Self-Localization Unit for comparing the objects or structures identified within the digitized scene and their orientation to objects or structures within one or more of the 3-dimensional construction site models, wherein: the specific construction site, the current stage of construction at the specific site, and/or the location and orientation of the scene digitizer within the construction site, are derived based on the successful matching of objects or structures in the analyzed digitized scene to corresponding objects or structures in one of the 3-dimensional models.

According to some embodiments, the system may comprise a Scene Inspector unit for comparing expected-view objects or structures, from the 3-dimensional model of a matching site, with features in the digitized scene of the site and registering the differences between parallel objects or structures in the two; and/or an Error Indicator Unit for indicating the registered differences between parallel objects or structures, found within both the digitized scene and the matching 3-dimensional construction site model and augmenting at least one visual representation of the differences on a digital display functionally associated with the scene digitizer.

According to some embodiments, object or structure differences, for which visual representations are augmented, may be selected from the group consisting of: incomplete objects or structures, erroneously completed objects and/or structures and objects or structures to be completed at a later construction stage.

According to some embodiments, the system may comprise a Construction Completion Engine for predicting a later construction stage view of ‘partially-built objects or structures’ in the viewed construction site scene—for which ‘partially-built objects or structures’ parallel objects or structures were found within the matching 3-dimensional construction site model—wherein the matching 3-dimensional construction site model includes at least one view of the objects or structures at a later construction stage; and/or for providing the Error Indicator Unit instructions for indicating and augmenting fully built, or later construction stage built, view(s) of scene objects based on the existing partially-built ones.

According to some embodiments, ‘partially-built objects or structures’ in the viewed construction site scene may be identified as partially-built, at least partially based on the matching of their texture to a texture found in a reference database including ‘partially-built objects’ or structures' textures′.

According to some embodiments, the digital representation may at least partially includes an image and/or a depth-map.

According to some embodiments, a successful matching of objects or structures in the analyzed digitized scene to corresponding objects or structures in one of the 3-dimensional models, may include at least the successful alignment of at least two points of an object or structure in the digital scene representation with corresponding points on its parallel object or structure in a 3-dimensional model.

According to some embodiments a structure may include a combination of two or more objects at a specific orientation.

According to some embodiments of the present invention, a Method for Computer Vision Based Inspection may comprise: acquiring a current digital representation of a real-world construction site scene as viewed from a specific position and at a specific angle of view; analyzing the acquired digital representation to recognize potential features of construction related objects within it and extracting parameters associated with features' dimensions or orientation within the scene; identifying construction related objects or structures based on the detected and extracted features, wherein identifying objects or structures at least partially includes referencing a database of construction sites' 3-dimensional models including objects or structures thereof; and/or comparing the objects or structures identified within the digitized scene and their orientation to objects or structures within one or more of the 3-dimensional construction site models, wherein: the specific construction site, the current stage of construction at the specific site, and/or the location and orientation within the construction site from which the digital representation was acquired, are derived based on the successful matching of objects or structures in the analyzed digitized scene to corresponding objects or structures in one of the 3-dimensional models.

According to some embodiments, the method may comprise: comparing expected-view objects or structures, from the 3-dimensional model of a matching site, with features in the digitized scene of the site and registering the differences between parallel objects or structures in the two; and indicating the registered differences between parallel objects or structures, found within both the digitized scene and the matching 3-dimensional construction site model and augmenting at least one visual representation of the differences on a digital display.

According to some embodiments, object or structure differences, for which visual representations are augmented, may be selected from the group consisting of: incomplete objects or structures, erroneously completed objects or structures and/or objects or structures to be completed at a later construction stage.

According to some embodiments, the method may comprise: predicting a later construction stage view of ‘partially-built objects or structures’ in the viewed construction site scene—for which ‘partially-built objects or structures’ parallel objects or structures were found within the matching 3-dimensional construction site model—wherein the matching 3-dimensional construction site model includes at least one view of the objects or structures at a later construction stage; indicating fully built, or later construction stage built, view(s) of scene objects based on the existing partially-built ones; and/or augmenting at least one visual representation of the fully built, or later construction stage built, view(s) on a digital display.

According to some embodiments, ‘partially-built objects or structures’ in the viewed construction site scene may be identified as partially-built, at least partially based on the matching of their texture to a texture found in a reference database including ‘partially-built objects’ or structures' textures′.

According to some embodiments, the digital representation may at least partially include an image and/or a depth-map.

According to some embodiments, a successful matching of objects or structures in the analyzed digitized scene to corresponding objects or structures in one of the 3-dimensional models, may include at least the successful alignment of at least two points of an object or structure in the digital scene representation with corresponding points on its parallel object or structure in a 3-dimensional model.

According to some embodiments, a structure may include a combination of two or more objects at a specific orientation.

The subject matter described above is provided by way of illustration only and should not be constructed as limiting. While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A Computer Vision Based Inspection System, said system comprising:
a Scene Digitizer for acquiring a current digital representation of a real-world construction site scene as viewed from a specific position and at a specific angle of view;
a Feature Detector/Extractor for analyzing the acquired digital representation to recognize potential features of construction related objects within it and for extracting parameters associated with features' dimensions or orientation within the scene;
a Vector Model Processor for identifying construction related objects or structures based on the detected and extracted features, wherein identifying objects or structures at least partially includes referencing a database of construction sites' 3-dimensional models including objects or structures thereof; and
a Self-Localization Unit for comparing the objects or structures identified within the digitized scene and their orientation to objects or structures within one or more of the 3-dimensional construction site models, wherein: the specific construction site, the current stage of construction at the specific site, or the location and orientation of said scene digitizer within the construction site, are derived based on the successful matching of objects or structures in the analyzed digitized scene to corresponding objects or structures in one of the 3-dimensional models.

2. The system according to claim 1, further comprising:
a Scene Inspector unit for comparing expected-view objects or structures, from the 3-dimensional model of a matching site, with features in the digitized scene of the site and registering the differences between parallel objects or structures in the two; and
an Error Indicator Unit for indicating the registered differences between parallel objects or structures, found within both the digitized scene and the matching 3-dimensional construction site model and augmenting at least one visual representation of the differences on a digital display functionally associated with said scene digitizer.

3. The system according to claim 2, wherein object or structure differences, for which visual representations are augmented, are selected from the group consisting of: incomplete objects or structures, erroneously completed objects or structures and objects or structures to be completed at a later construction stage.

4. The system according to claim 2, further comprising:
a Construction Completion Engine for predicting a later construction stage view of ‘partially-built objects or structures’ in the viewed construction site scene—for which ‘partially-built objects or structures’ parallel objects or structures were found within the matching 3-dimensional construction site model—wherein the matching 3-dimensional construction site model includes at least one view of the objects or structures at a later construction stage; and
providing said Error Indicator Unit instructions for indicating and augmenting fully built, or later construction stage built, view(s) of scene objects based on the existing partially-built ones.

5. The system according to claim 4, wherein ‘partially-built objects or structures’ in the viewed construction site scene are identified as partially-built, at least partially based on the matching of their texture to a texture found in a reference database including ‘partially-built objects’ or structures' textures′.

6. The system according to claim 2, wherein the digital representation at least partially includes an image or a depth-map.

7. The system according to claim 2, wherein a successful matching of objects or structures in the analyzed digitized scene to corresponding objects or structures in one of the 3-dimensional models, includes at least the successful alignment of at least two points of an object or structure in the digital scene representation with corresponding points on its parallel object or structure in a 3-dimensional model.

8. The system according to claim 2, wherein a structure includes a combination of two or more objects at a specific orientation.

9. A method for Computer Vision Based Inspection, said method comprising:
acquiring a current digital representation of a real-world construction site scene as viewed from a specific position and at a specific angle of view;
analyzing the acquired digital representation to recognize potential features of construction related objects within it and extracting parameters associated with features' dimensions or orientation within the scene;
identifying construction related objects or structures based on the detected and extracted features, wherein identifying objects or structures at least partially includes referencing a database of construction sites' 3-dimensional models including objects or structures thereof; and
comparing the objects or structures identified within the digitized scene and their orientation to objects or structures within one or more of the 3-dimensional construction site models, wherein: the specific construction site, the current stage of construction at the specific site, or the location and orientation within the construction site from which the digital representation was acquired, are derived based on the successful matching of objects or structures in the analyzed digitized scene to corresponding objects or structures in one of the 3-dimensional models.

10. The method according to claim 9, further comprising:
comparing expected-view objects or structures, from the 3-dimensional model of a matching site, with features in the digitized scene of the site and registering the differences between parallel objects or structures in the two; and
indicating the registered differences between parallel objects or structures, found within both the digitized scene and the matching 3-dimensional construction site model and augmenting at least one visual representation of the differences on a digital display.

11. The method according to claim 10, wherein object or structure differences, for which visual representations are augmented, are selected from the group consisting of: incomplete objects or structures, erroneously completed objects or structures and objects or structures to be completed at a later construction stage.

12. The method according to claim 10, further comprising:
predicting a later construction stage view of ‘partially-built objects or structures’ in the viewed construction site scene—for which ‘partially-built objects or structures’ parallel objects or structures were found within the matching 3-dimensional construction site model—wherein the matching 3-dimensional construction site model includes at least one view of the objects or structures at a later construction stage;
indicating fully built, or later construction stage built, view(s) of scene objects based on the existing partially-built ones; and
augmenting at least one visual representation of the fully built, or later construction stage built, view(s) on a digital display.

13. The method according to claim 12, wherein ‘partially-built objects or structures’ in the viewed construction site scene are identified as partially-built, at least partially based on the matching of their texture to a texture found in a reference database including ‘partially-built objects’ or structures' textures′.

14. The method according to claim 10, wherein the digital representation at least partially includes an image or a depth-map.

15. The method according to claim 10, wherein a successful matching of objects or structures in the analyzed digitized scene to corresponding objects or structures in one of the 3-dimensional models, includes at least the successful alignment of at least two points of an object or structure in the digital scene representation with corresponding points on its parallel object or structure in a 3-dimensional model.

16. The system method according to claim 10, wherein a structure includes a combination of two or more objects at a specific orientation.
